(19) United States
(12) Patent Application Publication
(10) Pub. No.: US 2009/0177714 A1
(43) Pub. Date: Jul. 9, 2009

(54) Method for Asynchronous catalog update

(75) Inventors: L. Lance Obermeyer, Austin, TX (US); Rajesh Ajmera, Bangalore (IN)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: 30 Second Software, Inc.

(21) Appl. No.: 12/082,862

(22) Filed: Apr. 15, 2008

Related U.S. Application Data
(60) Provisional application No. 60/926,026, filed on Apr. 23, 2007.

(51) Int. Cl. G06F 17/30; G06Q 30/00

(52) U.S. Cl. 707/203; 705/26; 707/E17.116; 707/E17.044

(57) ABSTRACT

A method for synchronizing a first data set stored on a mobile communications device with a second data set stored in another location, comprising (a) accessing the second data set while the user of the mobile communications device is accessing the first data set; and (b) updating the first data set in light of the second data set.

### CROSS-REFERENCE TO RELATED APPLICATIONS

This application claims priority from U.S. Provisional Patent Application 60/926,026 (Obermeyer et al.), entitled “Method for Asynchronous Catalog Update”, which was filed on Apr. 23, 2007, and which is incorporated herein by reference in its entirety.

### FIELD OF THE DISCLOSURE

The present disclosure relates generally to ecommerce, and more particularly to methods for updating ecommerce catalogs while the catalogs are being browsed by a user.

### BACKGROUND OF THE DISCLOSURE

Various ecommerce catalogs are known to the art. Examples of such catalogs include those which are currently associated with web sites such as “Yahoo! Shopping” and “Amazon.com”. These catalogs feature various products which are offered for sale and which are arranged in a particular organizational hierarchy. Typically, information about each product is provided. This may include a textual description of the product, the price it is being offered for sale at, and an image of the product.

The concept of sharing ecommerce catalogs is well known. Comparison shopping sites such as www.shopping.com receive ecommerce catalogs from their merchant partners. These so called “data feeds” are normally sent on a nightly basis, and include a complete set of the products the merchant partner is selling.

The use of ecommerce catalogs has been extended to Personal Digital Assistants (PDAs) and other mobile communications devices. Handango's IN-HAND™ and Handmark's POCKET EXPRESS™ mobile Internet solutions include locally maintained ecommerce catalogs. These applications also have reference ecommerce catalogs which are maintained on servers accessible from mobile communications devices.

### SUMMARY OF THE DISCLOSURE

In one aspect, a method is provided for synchronizing a first data set stored on a mobile communications device with a second data set stored in another location, comprising: (a) accessing the second data set; and (b) updating the first data set based on information contained in the second data set; wherein the first data set is updated while it is being browsed by a user of the mobile communications device.

In another aspect, a method for synchronizing a first catalog stored on a mobile communications device with a second catalog stored at another location is provided which comprises: (a) providing an ecommerce application which is adapted to access the second catalog to determine whether the first catalog is up to date, and wherein the ecommerce application is further adapted, if the first catalog is not up to date, to initiate an asynchronous process to update the first catalog; and (b) after the asynchronous process is initiated, returning control of the ecommerce application to the user.

In a further aspect, a system is provided for synchronizing a first catalog stored on a mobile communications device with a second catalog stored at another location, comprising an application which is adapted to (a) access the second catalog to determine whether the first catalog is up to date, (b) if the first catalog is not up to date, initiate an asynchronous process to update the first catalog, and (c) after the asynchronous process is initiated, return control of the application to the user; wherein the application is adapted to update the catalog while the user of the mobile communications device is browsing the catalog.

In yet another aspect, a method is provided for synchronizing a first catalog data set stored on a mobile communications device with a second catalog data set stored in another location, comprising: (a) creating a difference file which contains differences between the first and second catalog data sets; and (b) using the difference file to update the first catalog data set.

In still another aspect, a mobile communications device is provided comprising: (a) a memory device; (b) a document stored in said memory device which contains catalog content, wherein the catalog content includes conditional data which is enabled through an expression; (c) a display adapted to render images from said document; and (d) a program, resident on the mobile communications device, which is adapted to evaluate the expression based on a user's input, and which is further adapted to customize the display based on the conditional expression.

In another aspect, a method is provided for presenting data in a mobile communications device equipped with a display, comprising: (a) executing a query across a plurality of databases, thereby obtaining query results; and (b) rendering the query results on the display in a catalog format.

### BRIEF DESCRIPTION OF THE DRAWINGS

FIG. 1 is an illustration of a network suitable for implementing some of the methodologies taught herein; and

FIGS. 2-14 are screenshots depicting the registration process in a particular, non-limiting embodiment of a software program adapted to implement some of the methodologies disclosed herein;

FIGS. 15-29 are screenshots depicting the browsing process associated with online shopping in the software program of FIGS. 1-14; and

FIGS. 30-33 are screenshots depicting the “change settings” process associated with the software program of FIGS. 1-14.

### DETAILED DESCRIPTION

Despite their many advantages, one problem with existing ecommerce applications is that these applications utilize synchronous processes for updating ecommerce catalogs. That is, when the ecommerce application begins an update process to synchronize a locally stored ecommerce catalog with new information obtained from a reference ecommerce catalog, the user is forced to wait until the update process terminates before the catalog can be browsed. While this delay may not be particularly bothersome for a user accessing the catalog from a personal computer or laptop (especially if the user has a broadband connection), the situation is notably different for a user who is accessing the catalog from a typical mobile communications device. Such a user will often have to cope with a more expensive connection, and with connection speeds which vary widely and which may sporadically drop to zero.

Moreover, a user accessing an ecommerce catalog from a mobile communications device will typically have a lower attention span, and less of a tolerance for delay, than a corresponding user accessing the catalog through a PC-based web browser. Part of this is due to the way in which mobile communications devices (especially hand-held mobile communications devices) are typically used. For example, in contrast to PCs and laptops, mobile communications devices are frequently employed while the user is engaged in other activities which require a significant level of attentiveness, such as operation of a motor vehicle, participation in a business meeting, or attendance at a sporting event. In such circumstances, the user may have only a narrow window of opportunity to access the ecommerce catalog and to make a purchase. This aspect of mobile communications devices may be appreciated by considering the circumstances of a user who wishes to purchase flowers for his spouse while he is driving home, and needs to initiate and complete the transaction while he is waiting at a traffic light.

Due to the reduced bandwidth and reduced attention span commonly available to users of mobile communications devices, ecommerce applications may employ a locally stored catalog rather than relying on a network accessed master catalog. The use of a locally stored catalog is advantageous in that the data stored therein can be accessed almost instantaneously, versus having to wait for network transmission of remotely stored data, and hence is commensurate with the narrow time frames and attention spans typically available to a user of a mobile communications device.

However, the use of locally stored catalogs also poses certain challenges. In particular, the existence of the same catalog data in multiple locations, as is necessitated by the use of a master catalog in conjunction with a large number of remotely deployed catalogs, gives rise to large scale master-to-slave synchronization problems. Solutions to these synchronization problems are constrained by the aforementioned slower network connection speeds and the reduced attention spans typically available to users of mobile communications devices.

It has now been found that the above noted needs may be met through the provision of a process for efficiently updating catalog content in an ecommerce application deployed on a mobile communications device such that the user does not have to wait for the update to finish before using the application and browsing the catalog. Instead, the catalog refresh operation may be performed as an asynchronous process which can update local catalog content while the user is viewing that content. Since the user is not required to wait for completion of the catalog refresh operation in order to access the application, this approach is more conducive to the constraints placed on users of mobile communications devices.

Moreover, updates to the local catalog may be constrained to the portion of the catalog the user is accessing, to products that the user has expressed a specific interest in, to particular components of the catalog files (e.g., the pricing component), or to difference files which reflect only the differences between the user's version of a catalog and the most recent version of a master catalog. Consequently, the scale of the refresh operation may be dramatically reduced, thus allowing the refresh operation to conclude, in many instances, shortly after the user accesses the application, and simultaneously with browsing of catalog content by a user.

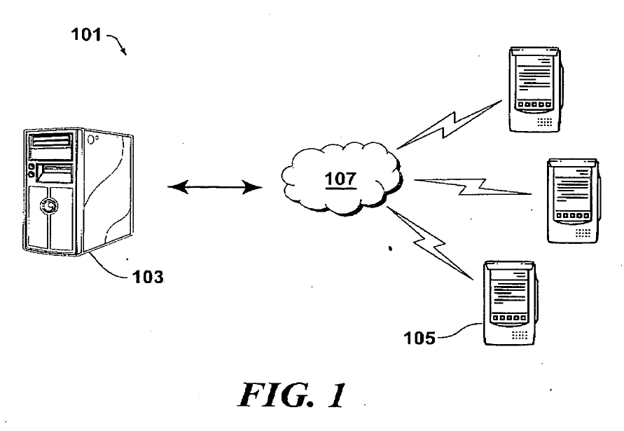

The methodologies disclosed herein may be implemented over a wide variety of systems and networks. One particular, non-limiting embodiment of such a system is depicted in FIG. 1. The system 101 disclosed therein comprises a server 103 which is in communication with a plurality of mobile communication devices 105 by way of a wireless network 107. The mobile communications devices may be handheld devices such as Personal Digital Assistants (PDAs) (including those sold under the trade mark BLACKBERRY™), cellular phones, and the like. Each of the mobile communications devices 105 in the system 101 is equipped with a deployed catalog which has been previously uploaded to the device. A master catalog is resident on the server 103, or on a memory device which is in communication with the server 103. While not specifically shown, the system 101 may be equipped with firewalls, load balancers, server farms, satellite nodes, and various other network components as are known to the art.

The master catalog is updated periodically (preferably daily) to provide the most recent information on the products described therein. This may be accomplished, for example, by the catalog producer in response to updated information received from the vendors whose products are offered for sale in the catalog. Each such update presents a master-to-slave synchronization problem for the catalogs deployed on the mobile communications devices 105.

In a preferred embodiment, a system of the type described herein contains three basic components: (1) the client device software, which is preferably Java ME software that runs on the mobile communications device; (2) a catalog which encodes the content, and which is shared between client and server; and (3) the server software, preferably Java EE software, that runs on one or more machines at a hosting center. These components will be described in greater detail below.

### A. Catalog

The catalog includes the mechanisms necessary to maintain a conceptually large catalog on a client mobile communications device. The client is responsible for downloading and storing content from the server which hosts the master catalog data. Such content may include the client application itself, the catalog, and price data.

The storage location for the catalog file may vary from one type of client device to another. In a BLACKBERRY™ mobile communications device, the catalog is stored in the device's “data store”, which is a device-supplied database for storing Java objects. An example of a full catalog file may be found at http://static.digby.com/catalog3/1172399820079-catalog.xml, which is incorporated herein by reference in its entirety.

The update process used to maintain the catalog file may be controlled by an .xml file, referred to herein as the “update.xml” file. An example of this file may be viewed at http://static.digby.com/catalog3/update.xml, which is incorporated herein by reference in its entirety. A particular, non-limiting embodiment of the update.xml file is as follows:

<?xml version=“1.0” encoding=“UTF-8” ?>

− <update timestamp=“1175483725343” timestampReadable=“**Sun Apr
01 22:15:25 CDT 2007”>

<application version=“1.1.0” baseline=“1.1.0”

url=“http://app.digby.com/digby/index.jsp” />

<catalog version=“1175438539453” baseline=“1169587084109”

url=“http://static.digby.com/catalog2” parts=“7” />

<price version=“1175697243484”
url=“http://app.digby.com/catalog2”

timestampReadable=“Wed Apr 04 09:34:03 CDT 2007” />

</update>

In a preferred embodiment of the systems and methodologies described herein, the application is configured such that, each time the client device is restarted, it checks to see whether the update.xml file should be downloaded. If the file has not been downloaded in the last 24 hours, it is downloaded. The update.xml file preferably has three main components: (1) an application component; (2) a catalog component; and (3) a price component. Each of these components is described in greater detail below.

1. Application Component

The application component lists the current version and the baseline version of the application. If the client's version of the application is less than the baseline version, a mandatory update preferably ensues, and the application begins to download an appropriate update from the supplied URL. If the client's version of the application is greater than the baseline version but is less than the current version, the update is optional, and the user is queried as to whether he wants an update to commence. If the client's version of the application is equal to the current version of the application, then the client device proceeds with its normal operation without initiating, or querying about, an update.

2. Catalog Component

Like the application component, the catalog component is also assigned a version. This version is preferably in the form of a Java timestamp, which is the number of milliseconds since Jan. 1, 1970. Hence, “1173067060343” equates to “Sun March 04 21:57:40 CST 2007”.

The catalog component is preferably a single large XML file with two subcomponents, a “hierarchy” subcomponent and an “items” subcomponent. The “hierarchy” subcomponent is defined by <menu> objects which describe a menu in the client, and the “items” subcomponent is defined by <item> objects which describe products. The objects in the “items” subcomponent are named using the convention [timestamp]+“-catalog.xml”.

a. Hierarchy Subcomponent

In a preferred embodiment of the “hierarchy” subcomponent of the catalog component, each <menu> has a series of <menuItem> objects. A menuItem is a pointer to something else, either another <menu> (type=subMenu) or an actual <item> (type=item). The following particular, non-limiting embodiment of the hierarchy illustrates the format of this subcomponent:

<menu menuId=“1” prev=“0” title=“Flowers and Plants”>
<menuItem type=“item” itemId=“0RRB” vendorId=“1”>
<name>Premium Red Rose Bouquet</name>
</menuItem>
<menuItem type=“subMenu” next=“111” count=“7”>
<name>Birthday</name>
</menuItem>
<menuItem type=“subMenu” next=“112” count=“10”>
<name>Special Occasions</name>
</menuItem>

b. Item Subcomponent

In a preferred embodiment, each <item> object in the “items” subcomponent of the catalog component includes a key of itemId and vendorId. Underneath the <item> are the different fields. The following particular, non-limiting embodiment of the “items” subcomponent illustrates the format of this subcomponent:

<item itemId=“C6-3067” vendorId=“1”>
<title>Festive Wishes ™ Bouquet</title>
<price>39.99</price>
<image>http://www.ftd.com/pics/products/C6-3067_a.jpg</image>
<bigImage>http://www.ftd.com/pics/products/C6-3067_c.jpg</bigImage>
<description title=“Description”> If wishes were flowers, they'd look like
this: a gala of yellows, pinks, peaches and purples, with feathery greens.
</description>
</item>

c. Delta File

Due to the common network limitation that files cannot be greater than 128 k, the catalog component is typically split into smaller chunks and is reassembled by the client. In the case where a client has a catalog version which is older than the current version but is newer than the baseline version, the client can download a “delta” file. The delta file contains only the changes between the two catalog versions, rather than the full catalog content. Consequently, downloading the delta file rather than the entire current version of the catalog may result in a much smaller download, and using the delta file to implement an update may significantly accelerate the update process.

The process of updating content on a device which already has a catalog may be optimized as follows. When a client having a catalog with timestamp “o” determines from update.xml that that the current catalog has timestamp “n”, the client will request the file “n-o-delta.xml”. An example of this file may be viewed at http://static.digby.com/catalog3/1173535832671-1172479679664-delta.xml, which is incorporated herein by reference in its entirety.

A delta file contains only the changes from o to n. There are potentially six different types of changes which may be reflected in the delta file:

(1) Removal of an existing menu;

(2) Modification of an existing menu;

(3) Addition of a new menu;

(4) Removal of an existing item;

(5) Modification of an existing item; and

(6) Addition of a new item.

The appropriate -delta.xml file may contain data in each category. Preferably, a client application processes the delta file to bring its local catalog up to date, and then stores the timestamp of the new catalog.

3. Price Component

In a preferred embodiment, the price component is designed with the realization that prices typically change much more rapidly than other types of catalog content. Hence, the price component includes a separate price file, which provides a means by which price data may be rapidly updated on a client device without requiring the client device to download a full catalog. In its preferred embodiment, the price file is simply a list of product IDs (item ID+vendor ID) and prices, and hence each object in the price file has the configuration

<price itemId=“B000002IRS” vendorld=“2” price=“80.99”/>

A particular, non-limiting embodiment of the price component may be viewed at http://static.digby.com/catalog3/1173258796560-price.xml, which is incorporated herein by reference in its entirety.

In some embodiments of the systems described herein, the system may be adapted to support “configured” and “conditional” items. Configured items are items where some amount of customization must be performed by the user. For example, if the item is “pizza”, it may have configured items “topping 1”, “topping 2”, and “topping 3”, and may also have conditional items “side” and “dressing”. If a side dish is selected that is “salad”, then a configuration option for “dressing” is enabled.

### B. Server

The server utilized to implement the methodologies described herein is preferably a Java EE application running at a hosting center. The server will typically have the following primary functions:

(1) registration;

(2) search;

(3) order; and

(4) reporting.

1. Registration

In a preferred embodiment of the systems and methodologies disclosed herein, the server is adapted to support a web service for registration. The client sends the server an XML document containing the registration information, which may include such details as name, password, address, and phone number. The server checks this data for validity. If the data is valid, the server sends an indication thereof to the client device and stores the information in a local database. The registration process is synchronous (that is, it occurs while the user is waiting).

2. Search

In a preferred embodiment of the systems and methodologies disclosed herein, the server is adapted to support a web service for searches. The client sends the server an XML document containing search data, such as product category or search terms. The server then checks this data for validity, a process which may involve, for example, verifying that the keyword is not empty.

If the search data is valid, the server immediately executes an equivalent search against one or more merchant websites. For example, when the user searches for “Grisham” in the “books” category, the search terms [Grisham, books] are sent to the server. In response, the server immediately searches Amazon.com, or another suitable database, for “Grisham”. The search results from Amazon.com are reformatted into catalog content by the server. Specifically, a new <menu> object is created with nested <menuitem> objects and a set of <item> objects. Using the catalog data structures allows search result content to be easily added to the catalog, and to be ordered by the user using the standard procedures developed for other types of merchandise.

3. Order

In a preferred embodiment of the systems and methodologies disclosed herein, the server is adapted to support a web service for orders. Preferably, the client sends the server an order in the form of an XML document containing the order information, which may include items, quantities, credit card information, a shipping address, and the like. The server checks this data for validity by checking, for example, that the customer is a valid customer, and that the products specified in the order are valid products.

If the data is valid, the server sends an indication thereof to the client device, stores this information in a local database, and initiates an asynchronous order placement process that submits the order to one or more vendors. The use of an asynchronous order process is advantageous because the time it takes to submit the order may be beyond the attention span of the user.

The order processor may take multiple forms. The particular form utilized may depend on the capabilities of the vendor, but will typically be in one of the following formats:

(a) Web site post: In this scenario, the server mimics the actions of a human user. Thus, it accesses a vendor's web site (such as www.amazon.com), finds the product that the user wants to buy, selects the “add to cart” button, selects the “checkout” button, and fills in all of the forms required to actually place the order.

(b) XML transmit: In this scenario, the server creates an XML document with the order details, and sends it to the vendor. The vendor may return a result to the server, which may include, for example, confirmation of receipt or the final price.

(c) Email: In this scenario, the server creates an email with the same information as the XML document and sends it to the vendor. The vendor's customer service representative may then enter the order into the vendor's internal order management system.

In some embodiments of the systems and methodologies described herein, the logic required to determine a final price for an order may be too complicated to encode on a mobile communications device, since the result may depend on a variety of factors, such as tax tables and shipping rates, which may not be known or which may require excessive memory space or processing resources to host directly. As a result, absent other measures, the user may not know the final price of an order before placing the order.

However, in some embodiments of the systems and methodologies described herein, this issue may be dealt with through the provision of a web service which is supported by the system and which calculates the final price of an order before the user actually confirms the order. In such embodiments, the client device may send a message to the server with a proposed order, and the server may respond in real time with the final price, if it is available.

### C. Client Software

The client software serves several major functions. These include:

a. Downloading the catalog to the device;

b. Displaying catalog data to the user;

c. Maintaining a shopping cart;

d. Maintaining registration data on the device;

e. Uploading registration data to the server; and

f. Uploading order data to the server.

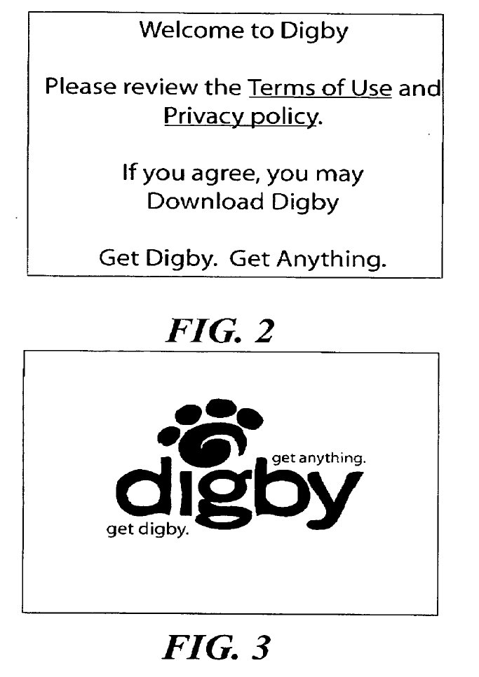

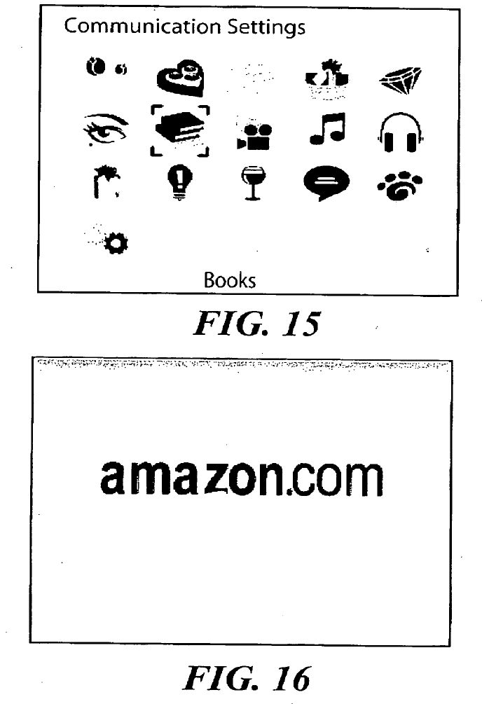

The client software may be appreciated through the particular, non-limiting embodiment depicted in the screenshots of FIGS. 2-33.

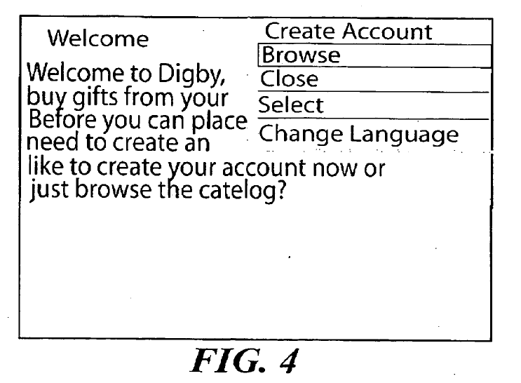

FIG. 2 depicts the download screen which is displayed when a user navigates to a website (e.g., www.digby.com/download) hosted by the server. The download screen is equipped with hotlinks to web pages containing the privacy policy and terms of use. Selecting the “Download Digby” button installs the application. When the downloaded application is opened, it brings up, in succession, the splash screen depicted in FIG. 3 and the welcome screen depicted in FIG. 4.

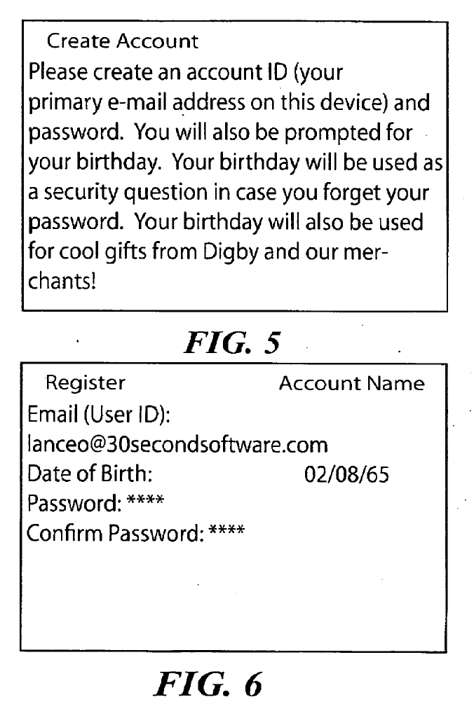

The welcome screen allows the user to create an account, which is handled by a “create account” wizard, or in the alternative, to proceed directly to browsing the catalog (the later course of action is preferably specified as the default). The operation of the “create account” wizard is depicted in FIGS. 5-14. A new user who chooses to browse the catalog rather than create an account, and then later places an order, will be redirected to the “create account” wizard upon initiating the checkout process.

The first screen of the “create account” wizard is the informational screen depicted in FIG. 5. It is followed by the screen depicted in FIG. 6 which queries the user for a username, date of birth, and password, the later of which must typically be at least three digits. The birth date is a required field and is utilized for password authentication. In the event that a password is lost, it is presumed that the client device is in the hands of an unauthorized user. Hence, in order to retrieve a password, the user is instructed to contact support, where he is required to provide the birth date. If the user cannot do so, the user is instructed to delete and reinstall the application. This has the effect of wiping the local memory which is used to store credit card information and other sensitive data associated with the software.

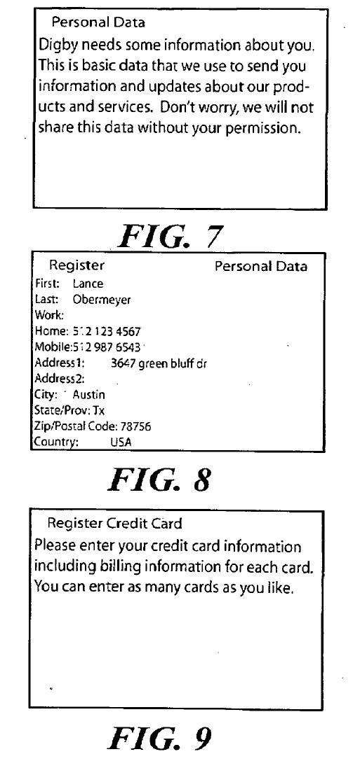

After the user inputs a valid username, date of birth, and password, the user is brought to the informational screen depicted in FIG. 7. This screen is followed by the screen depicted in FIG. 8, where the user is requested to provide contact data. This contact data is used as the default data for the credit card billing address and as the “send to self” address which is selectable during check-out.

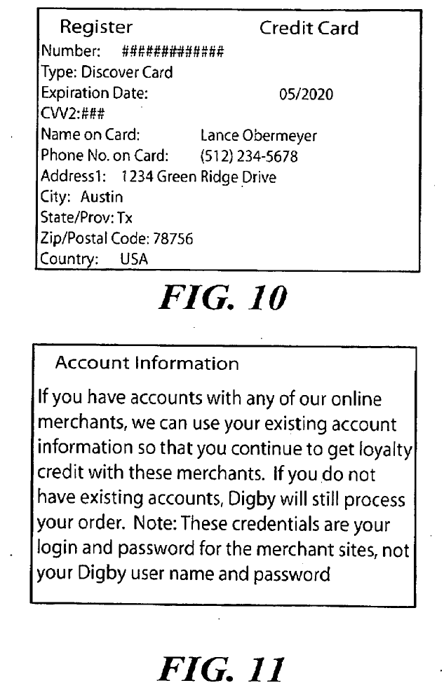

After contact information is provided, the user is brought to the informational screen of FIG. 9. This screen is followed by the screen of FIG. 10, where the user enters credit card information relating to one or more credit cards. Entry of the credit card information is facilitated by an electronic wallet feature built into the software, which automatically populates the fields on this screen. This feature enables the user to enter credit card numbers, expiration dates, billing, and other requested information, and to complete a purchase, all preferably within a 30 second time frame.

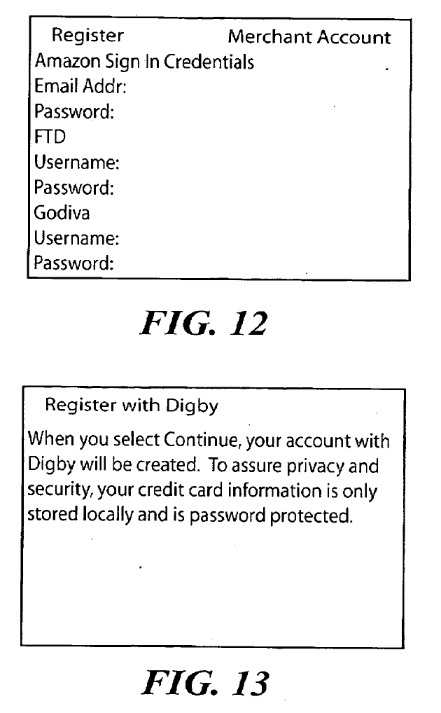

The informational screen depicted in FIG. 11 follows, which provides useful vendor information. This screen is followed in turn by one or more screens which prompt the user to enter vendor account information. An example of such a screen is depicted in FIG. 12. After this information is entered, the user is brought to the informational screen depicted in FIG. 13.

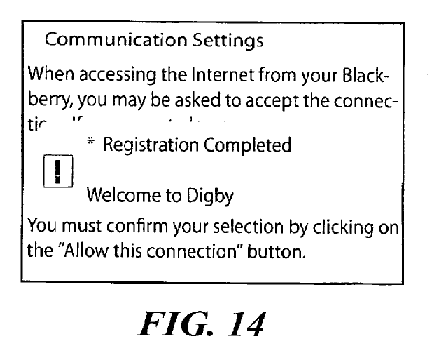

Upon selection of the “continue” button, registration is completed, as indicated by the informational screen of FIG. 14. At this point in the process, all entered data is saved to the local memory of the mobile communications device. In the case of a BLACKBERRY™ mobile communications device, the device includes a native embedded database in which database objects are keyed to an application, so that deletion of the application necessarily deletes the associated stored data as well. Consequently, a user browsing the device file system or an application without the necessary key will not be able to access the data.

Also at this point in the process, a subset of the data is sent to the server hosting the catalog to reduce the loss of customer data in the event of a server breach. Preferably, only the data collected in the screens of FIGS. 6 and 8 (account details and home address) are sent to the server, and the information collected on the screens of FIGS. 10 and 12 (credit card and merchant accounts) is not sent.

FIGS. 15-29 depict the browsing screens associated with online shopping. The screen of FIG. 15 is a category screen which serves as the home page. The first 13 items on the screen are product categories, each of which contains products from a specific vendor. Thus, flowers are from FTD, candy is from Godiva Chocolatier, teddy bears are from Vermont Teddy Bears, gift baskets are from Capalbos, and the remaining items are from Amazon.com. The call-out icon is “Tell a Friend”, which sends an email about the system to a person in the user's address book. The paw icon is “Tell Digby”, which sends a feedback message to the system manager. The icon consisting of a set of gears is “settings” which, when selected, allows the user to modify various program settings.

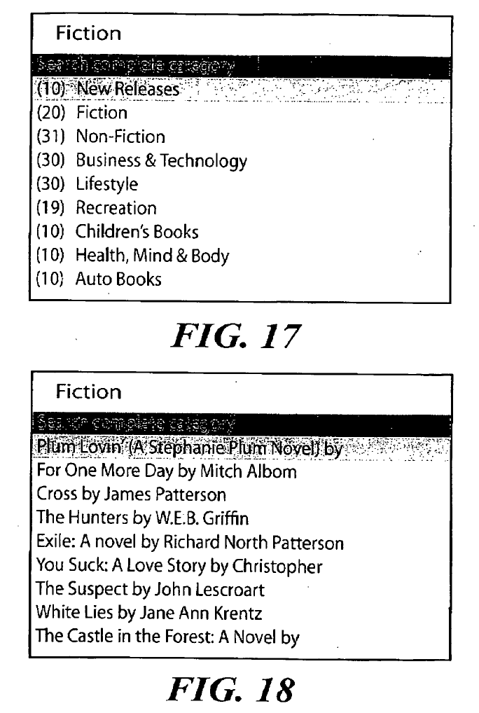

When a product category is selected, a splash screen is generated. An example of such a splash screen is shown in FIG. 17. The splash screen displays the logo of the vendor associated with the product category for a specified duration (preferably 1.5 seconds), thus communicating to the user the vendor of the products they are browsing. The splash screen then automatically disappears and is replaced with a category listing, an example of which is shown in FIG. 18. The category listing contains a category tree of arbitrary depth, and any individual listing may contain both subcategories and items. Selecting a line in the category listing takes the user to either the subcategory or the item description.

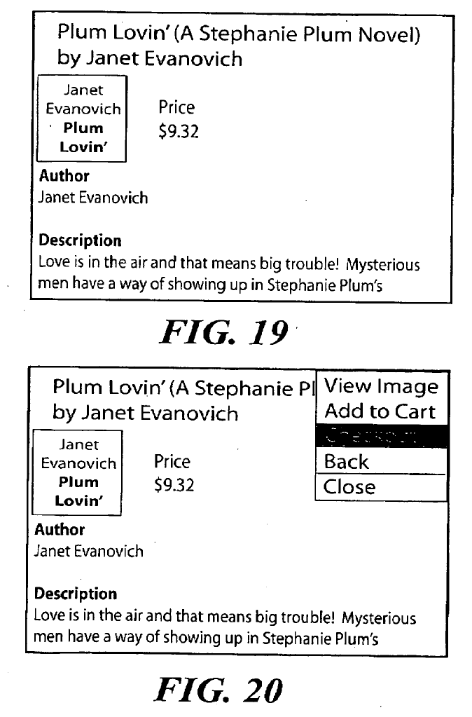

FIG. 19 shows an example of an item description screen. As seen therein, the item description begins with a highlighted title, and may contain an image of the item, the price of the item, and descriptive attributes of the item. Thus, for example, if the item is a book, the item description screen may provide the author, a summary of the book, comments from reviewers, an indication as to whether the book is a paperback or hardcover, and the like. An item description page may be longer than the screen on the mobile communications device, so the user may be required to scroll down to view all of the content. As shown in FIG. 20, on any item page, the user may add the item to a shopping cart, after which the user has the option of continuing to browse or proceeding to the checkout.

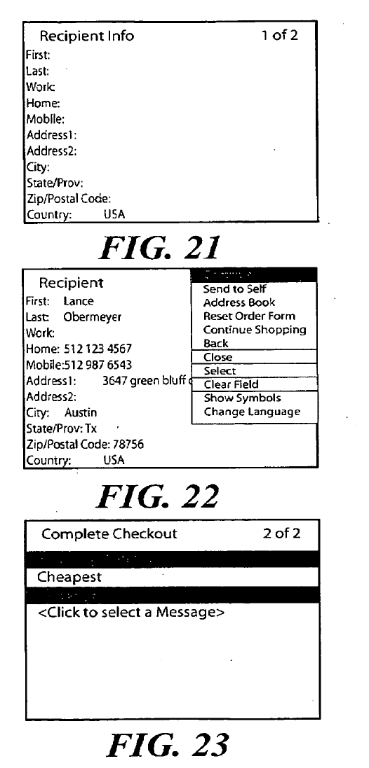

FIG. 21 depicts the first screen of the checkout process. The user initiates the checkout process by setting the recipient information. This may be accomplished, for example, by choosing “Send to Self”, which automatically populates the fields on the screen with information obtained from the user during set-up. A recipient may also be specified by selecting a recipient from the user's “Address Book” (which again automatically populates the fields with the relevant information), or by manually entering the required information into the fields.

As shown in FIG. 22, after a recipient is chosen, the user may either clear the selection or modify some of its fields. If the user chooses to continue, he is taken to the screen shown in FIG. 23, where a shipping method and gift message may be specified. The server is preferably adapted to map the options “Cheapest” and “Fastest” to the appropriate vendor options. For example, selecting “Cheapest” in an Amazon.com category will be free shipping, if that option is available. Choosing either “Cheapest” or “Fastest” in the FTD flowers category maps to local florist delivery.

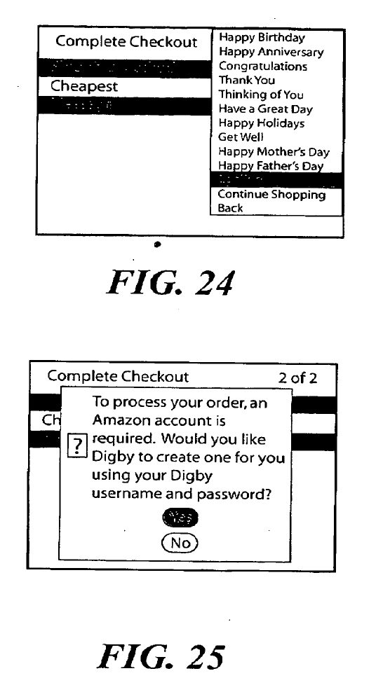

As shown in FIG. 24, there are several gift message options available to the user. These include selecting a gift message from a predefined list, entering a gift message manually, or leaving the field blank. The user then confirms the order if he wishes to proceed.

If the user confirms the order, the next screen depends on the vendor. If the vendor supports orders in the absence of an account, the user is directed to the screen in FIG. 27, where the order may be confirmed through the entry of the user's password. If the vendor requires an account as a condition precedent to placing an order, the software checks to see if the user already has an account registered for that vendor, and proceeds to the screen in FIG. 27 if an appropriate account is found. If no account with the vendor has been registered, the user is prompted with the message screen shown in FIG. 25.

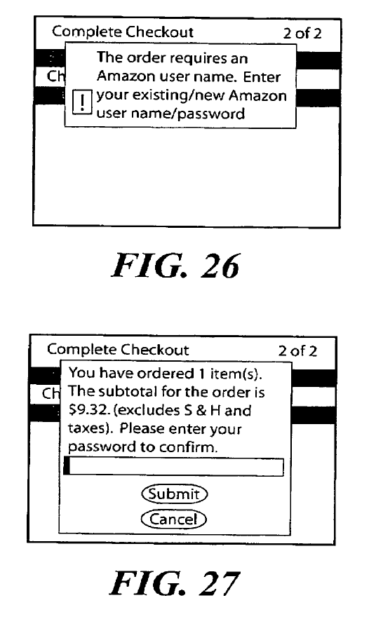

If the user selects “Yes” on the screen shown in FIG. 25, the software will use the username (preferably, the user's email address) and password specified during set-up to create an account with the vendor on the user's behalf. If the user selects “No”, the screen depicted in FIG. 26 is flashed briefly (preferably for about two seconds), after which the user is redirected to the “create account” screen shown in FIG. 5. After the user enters credentials, he proceeds to the confirmation screen shown in FIG. 27. If no credentials are entered, the user is not permitted to proceed to the order.

The confirmation screen shown in FIG. 27 presents the subtotal of the order, and explicitly informs the user that shipping, handling and taxes are extra. The order is not placed until the user enters the appropriate password, thus preventing an unauthorized user from placing orders on the device.

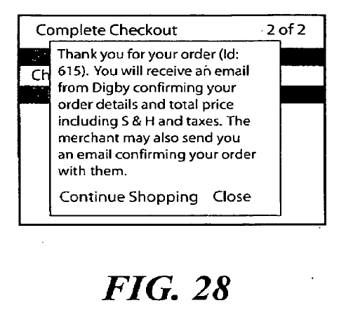

If proper credentials are entered, the order details are sent to the server for processing, after which the screen shown in FIG. 28 is displayed. This ends the process from the user's perspective. Notably, the workflow of the process is designed so that the user does not have to wait during order posting, since this may add several seconds to the user's perceived order process, which may cause it to exceed the user's available attention span.

After an order is placed, the order is posted to the vendor. In some cases, this may involve placing the orders on the vendor's website using a form posting scheme. In other cases, the order may be encrypted and emailed. In some cases, the vendor may send follow-up emails to the user.

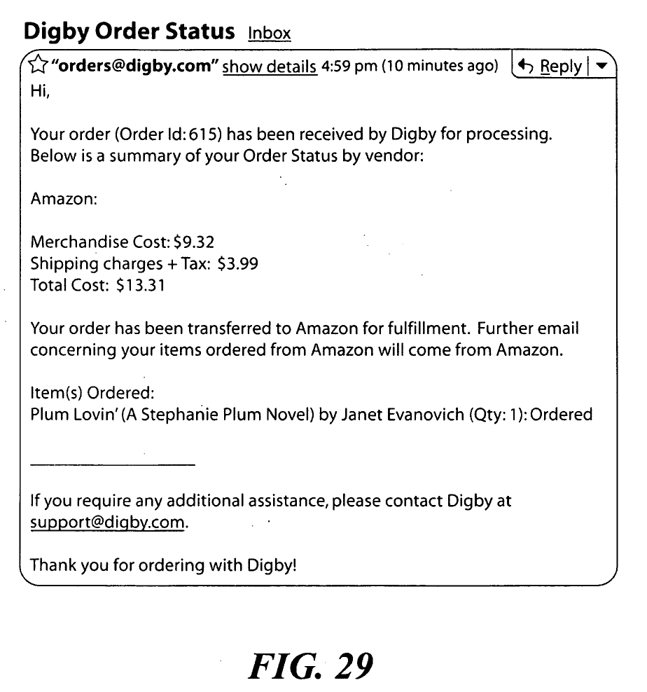

After order placement, the software will also send a confirmation email to the user with order details. The confirmation will preferably include the total price, and may be displayed on the device in a special pop-up screen, an example of which is shown in FIG. 29.

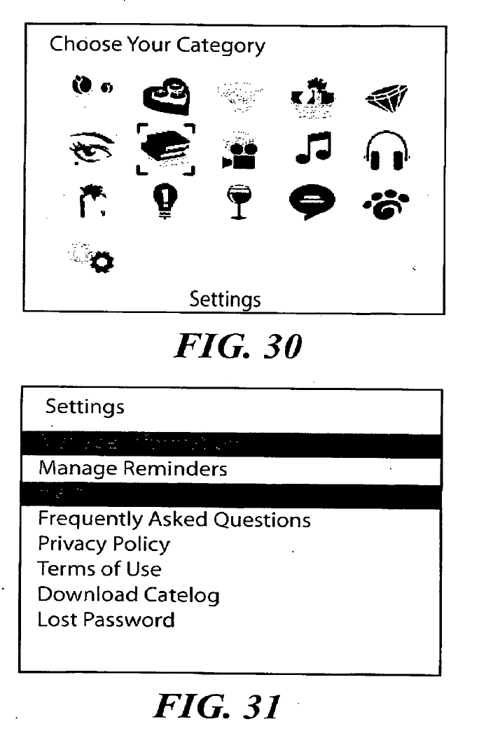

The user may configure the software by adjusting its settings through selection of the “Settings” icon, as shown in FIG. 30. The subsequent settings screen, which is shown in FIG. 31, allows the user to perform non-shopping tasks. Thus, selecting the “Help”, “FAQ”, “Privacy”, or “Terms” options brings up properly formatted web pages from the server (www.digby.com) with the appropriate information. Selecting “Download Catalog” forces a refresh of the catalog content. Selecting “Lost Password” brings up a form to email support.

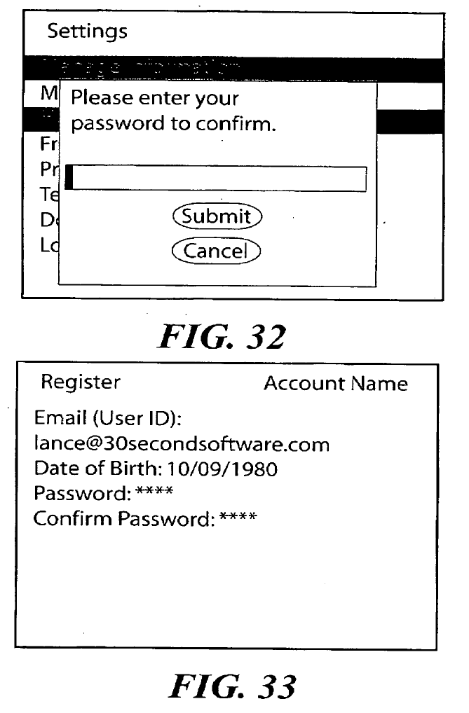

As shown in FIG. 32, the selection “Manage Information” is a gateway to personal information, and hence is password protected. Selecting “Manage Information” brings up the first screen in the “create account” wizard, as shown in FIG. 33. The user may then navigate through the screens as indicated above.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for synchronizing a first data set stored on a mobile communications device with a second data set stored in another location, comprising:
accessing the second data set; and
updating the first data set based on information contained in the second data set;
wherein the first data set is updated while it is being browsed by a user of the mobile communications device.

2. The method of claim 1, wherein the first data set is a catalog.

3. The method of claim 1, further comprising:
creating a difference file which contains differences between the first and second data set; and
using the difference file to update the first data set.

4. The method of claim 3, further comprising:
ascertaining the version of the first data set; and
using the version to construct the difference file.

5. The method of claim 3, wherein the first data set is updated by:
contacting a server in communication with a data storage medium in which the second data set is stored;
communicating a request for the difference file to the server;
receiving the difference file; and
utilizing the difference file to update the first data set.

6. The method of claim 3, wherein the first data set is divided into a plurality of sections, and wherein only the sections of the first data set which are browsed by the user are updated.

7. The method of claim 6, wherein the difference file is limited to the sections of the first data set accessed by the user.

8. A method for synchronizing a first catalog stored on a mobile communications device with a second catalog stored at another location, wherein the first catalog is browsed with an ecommerce application, the method comprising:
accessing the second catalog;
determining whether the first catalog is up to date;
if the first catalog is not up to date, then (a) assuming control of the ecommerce application from the user, and (b) initiating an asynchronous process to update the first catalog; and
after the asynchronous process is initiated, returning control of the ecommerce application to the user.

9. The method of claim 8, where the asynchronous process is implemented using an operating system process which is separate from a user visible process.

10. The method of claim 8, where the asynchronous process is implemented using a thread within a user visible process.

11. The method of claim 8, where each component of the first catalog has a time stamp.

12. The method of claim 8, wherein time stamp comparisons are used to determine whether a portion of the first catalog is up to date.

13. The method of claim 8, wherein the ecommerce application includes a shopping cart, and wherein the asynchronous process is adapted to update data within the shopping cart.

14. The method of claim 8, where updating of the first catalog is performed using a differential technique such that only changed data is transferred from the second catalog to the mobile communications device.

15. The method of claim 8, where the asynchronous process that updates the first catalog employs a locking scheme which ensures that an item which the user of the mobile communications device is currently viewing is not updated.

16. The method of claim 15 wherein, after the item is closed, the lock is released, and the item is updated.

17. The method of claim 15, wherein the locking scheme is applied to items in a shopping cart.

18. The method of claim 8, wherein the asynchronous process that updates the first catalog employs a notification scheme adapted to notify the user of the mobile communications device that the item they are currently viewing in the first catalog has been updated.

19. The method of claim 18, wherein the notification scheme is applied to items in a shopping cart.

20. A method for synchronizing a first catalog data set stored on a mobile communications device with a second catalog data set stored in another location, comprising:
creating a difference file which contains differences between the first and second catalog data sets; and
using the difference file to update the first catalog data set.

21. The method of claim 20, wherein the first and second catalog data sets have first and second time stamps associated therewith which indicate the date on which the first and second catalog data sets were created, and wherein the first and second time stamps are utilized to create the difference files.

22. The method of claim 21, wherein the first and second time stamps further indicate the time of day on which the first and second catalog data sets were created.

23. The method of claim 21, wherein the second catalog data set is stored on a server, and wherein the server is adapted to create a difference file based on the first and second time stamps.

24. The method of claim 23, wherein the server creates the difference file upon request by the mobile communications device.

25. The method of claim 23, wherein the server contains difference files corresponding to the differences between the newest version of the second catalog data set and each member of a set of previous versions of the second catalog data set, wherein the first data set corresponds to a previous version of the second catalog data set, and wherein the server ascertains the version of the second catalog data set to which the first data set corresponds.

26. The method of claim 25, wherein the server transmits the appropriate difference file to the mobile communications device upon demand.

27. The method of claim 25, wherein the first catalog data set is divided into a plurality of sections, wherein each difference file is divided into a plurality of sections, and wherein the sections of the difference file have a one-to-one correspondence to the sections of the second catalog data set.

28. The method of claim 26, wherein the server transmits the appropriate section of the difference file to the mobile communications device upon demand.

29. The method of claim 26, wherein the mobile communications device is equipped with an application adapted to request the difference file corresponding to the first catalog data set when the mobile communications device accesses the first catalog data set.

30. The method of claim 28, wherein the mobile communications device is equipped with an application adapted to request the section of the difference file corresponding to a first section of the first catalog data set when the mobile communications device accesses the first section of the first catalog data set.
